(19) United States
(12) Patent Application Publication
(10) Pub. No.: US 2021/0067425 A1
(43) Pub. Date: Mar. 4, 2021

(54) MULTI-LEVEL DATA CHANNEL AND INSPECTION ARCHITECTURES INCLUDING OFF-ROAD DATA DIVERSION PATHS FOR LIMITING BANDWIDTH CONSUMPTION BY THE ARCHITECTURES

(71) Applicant: Bank of America Corporation, Charlotte, NC (US)

(72) Inventors: Rajesh Narayanan, Chennai (IN); Manu Kurian, Dallas, TX (US)

(21) Appl. No.: 16/553,483

(22) Filed: Aug. 28, 2019

(51) Int. Cl. H04L 12/26; H04L 12/24; H04L 12/46

(52) U.S. Cl. CPC H04L 43/028; H04L 12/4633; H04L 41/04; H04L 41/0896

(57) ABSTRACT

A method may include providing data diversion paths, each formed from a data conduit; diverting data packets from a data stream into a selected one of the data conduits. The data stream transfers data packets at a first transfer rate; then the system may determine packet size of a data packet in the data stream; select a conduit from among the conduits, depending on a data packet size. The conduit may receive and inspect data packets greater than a predetermined data packet size. The first data conduit receives, inspects and outputs data packets at a second transfer rate, less than the first transfer rate. The second data conduit receives, inspects and outputs relatively smaller data packets; inspects and outputs data packets at a third transfer rate, where the third transfer rate may be less than the first transfer rate and greater than the second transfer rate.

### FIELD OF TECHNOLOGY

Aspects of the disclosure relate to data architectures. Specifically, aspects of the disclosure relate to architectures for use in verifying and authenticating data in data streams.

### BACKGROUND OF THE DISCLOSURE

Digital packet inspection (sometimes referred to as deep packet inspection) (“DPI”) inspects in detail the data being sent over a computer network. At times, DPI can take actions, with respect to the data, such as blocking, re-routing, or logging the data. DPI is often used to ensure that the data is, inter alia, in correct format, to check for malicious code, eavesdropping and for internet censorship.

Many DPI methods, however, are slow and bandwidth-consumptive. This limits their effectiveness—especially for use with high-bandwidth applications. It would be desirable to develop more efficient methods of DPI.

While special routers are being developed to perform DPI, it would also be desirable to develop architectures that are directed to increasing speed and performance of DPI. It would be yet further desirable to increase speed and performance of DPI, yet, at the same time reduce the bandwidth consumption by DPI.

### SUMMARY OF THE DISCLOSURE

A deep packet inspection architecture is provided. The deep packet inspection architecture preferably provides data diversion path(s) for limiting bandwidth consumption by the deep packet inspection architecture. The diversion paths are preferably formed from a plurality of data conduits. The plurality of conduits may include a first data packet inspection conduit and a second data packet inspection conduit. The deep packet inspection architecture preferably diverts data packets in a data stream into one of the plurality of data conduits. The data stream preferably transfers data packets at a first transfer rate per unit time.

The deep packet inspection architecture may also include a data packet size determination module. The data packet size determination module may preferably determine a data packet size of a data packet in the data stream.

The deep packet inspection architecture may also include a data packet conduit selection module. The data packet conduit selection module may preferably select, for data packet inspection, a conduit from among the plurality of conduits. The selecting the conduit preferably depends on a data packet size of the data packet.

The first data conduit may be configured to receive and inspect data packets that include a data packet size that is greater than a predetermined data packet size. It should be noted that the ability to receive and inspect data packets, disclosed with respect to any of the data conduits referred to herein, may include a dynamic ability whereby, dependent on the traffic, or on any other suitable characteristic, the data conduit(s) may be able to receive and inspect varying, preferably configurable, sizes of data packets. Furthermore, it should be noted that the ability to receive and inspect data packets, disclosed with respect to any of the data conduits referred to herein, may include a dynamic ability whereby, dependent on the traffic, or on any other suitable characteristic, the data conduit(s) may be able to receive and inspect varying, preferably configurable, security levels of data packets.

The first data conduit that may further be configured to receive, inspect and output data packets at a second transfer rate per unit time. The second transfer rate per unit time is preferably less than the first transfer rate per unit time.

The second data conduit may be configured to receive and inspect data packets that include a data packet size that is less than or equal to the predetermined data packet size. The second data conduit may be further configured to receive, inspect and output data packets at a third transfer rate per unit time. The third transfer rate per unit time is preferably less than the first transfer rate per unit time and greater than the second transfer rate per unit time. Such an arrangement preferably conserves bandwidth at least because the conduits divert packets for inspection from the main data stream. The main data stream preferably transfers packets at a higher transfer rate per unit time than the data conduits at least because the data conduits review and inspect the packets, while the main data stream typically does not. So diverting packets for inspection to the data conduits—“off-road” so to speak—preferably maintains the bandwidth of the main data stream while adding a review and analysis to the selected data packets, and/or diverted data streams.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative architecture include mechanisms within a data analysis and review conduit in accordance with principles of the disclosure;

FIG. 2A shows another illustrative network architecture including a multi-level data pipeline in accordance with principles of the disclosure;

FIG. 2B shows yet another illustrative network architecture including a multi-level data pipeline, with various pipes disposed in a serial connection in accordance with principles of the disclosure;

FIG. 2C shows yet another illustrative network architecture including a multi-level data pipeline, with various pipes disposed in a parallel fashion in accordance with principles of the disclosure;

FIG. 2D shows still another illustrative network architecture including a multi-level data pipeline, the pipeline including various pipes disposed in a parallel fashion and the pipeline further including front end and back end logic blocks, in accordance with principles of the disclosure;

FIG. 2E shows an illustrative network architecture including a multi-level data pipeline, with various pipes disposed in a parallel fashion, the pipeline including front end and back end logic blocks for parsing a data stream and reconstructing same, in accordance with principles of the disclosure;

FIG. 2F shows still another illustrative network architecture including a multi-level data pipeline, with various pipes disposed in a parallel fashion, each pipe configured to transfer a different packet size, in accordance with principles of the disclosure;

FIG. 2G shows still another illustrative network architecture including a multi-level data pipeline, with various pipes disposed in a parallel fashion, each pipe having a unique data transfer rate, in accordance with principles of the disclosure;

FIG. 3A shows an illustrative system architecture including a data review tunnel in accordance with principles of the disclosure;

FIG. 3B shows another aspect of the data review tunnel from FIG. 3A in accordance with principles of the disclosure;

FIG. 3C shows yet another aspect of the data review tunnel from FIG. 3A in accordance with principles of the disclosure;

FIG. 3D shows still another aspect of the data review tunnel from FIG. 3A in accordance with principles of the disclosure; and

FIG. 4 shows yet another illustrative network architecture in accordance with principles of the disclosure.

### DETAILED DESCRIPTION OF THE DISCLOSURE

Aspects of the disclosure relate to architectures and methods associated therewith according to certain embodiments. Preferably present structures for intercepting the data and/or hiding/altering the contents of the data. The architectures set forth herein enables intercepting the data and/or hiding/altering the contents of the data because the analysis and review of the data is preferably performed by the architectures either prior to loading of the data into the greater system and/or at certain selected, preferably pre-determined, points of the data channel.

Theoretically, the architectures of the current embodiments can preferably be conceived of as a horizontal review system. Such a review system may preferably be configured to process data streams, data objects, and/or data sets (collectively referred to herein as, the “data”). Each of the above preferably have multiple parts, varying content and different data types. Accordingly, the architectures fill a need to create a tiered inspection layer that allows data to be inspected, not just as a packet level but in varying gradations—i.e., varying levels of inspection. Creating this multi-level data “filter” architecture preferably enables the data to be searched in various gradations of searching. In addition, such an architecture passes the data through different quality assurance parameters. Checking the data with respect to such parameters informs analysis and review (“A&R”) of the data along with certifying the data vis-à-vis other functional workflows.

The embodiments of the architecture disclosed herein involve comprehensive A&R channeling across one or more digital pipes.

A basic channel may include the following—

Data Packets (DP1, DP2, DPn)−x.

Each of data pipes (L1, L2, Ln) may include complementing pairs. The Data pipes can be segmented into levels each having specific/varying data attribute/metadata extracting capability. For the purposes of the disclosure herein, L1, a first data pipe, should be considered a basic data audit trail. Each new layer—i.e., L2 to Ln—may preferably add a new set of policies and requirements.

Relatively large amounts of real-time, or streaming, data requires one or more data processing pipelines. Each pipeline preferably contains paired pipe layers, the advantages of which will be described below in more detail.

A multi-spoke data inspection tunnel architecture is provided. The architecture may include a data tunnel. The data tunnel may include a data review tunnel module. The data review tunnel module may include a data collector module. The data collector module is preferably in electronic communication with the data review tunnel module in a hub and spoke relationship. The data review tunnel module preferably represents the hub and the data collector module preferably represents a spoke. In the hub and spoke model, inter-spoke electronic communication—i.e., communication between the various spokes—typically, though not always, proceeds via the hub—e.g., the data review tunnel module.

The data tunnel may also include an interpreter module. The interpreter module is preferably in electronic communication with the data review tunnel module in a hub and spoke relationship where the data review tunnel module preferably represents the hub and the interpreter module represents a spoke additional to the data collector module.

The data tunnel may also include a data review decision rules module. The data review decision rules module is preferably in electronic communication with the data review tunnel module in a hub and spoke relationship where the data review tunnel module preferably represents the hub and the interpreter module represents yet another spoke additional to the data collector module and the interpreter module.

The data tunnel may also include a data reporter module. The data reporter module may preferably be in electronic communication with the data review tunnel module in a hub and spoke relationship where the data review tunnel module preferably represents the hub and the interpreter module represents yet another spoke additional to the data collector module, the interpreter module and data review decision rules module.

In some embodiments, the data review tunnel module may be configured to receive a data stream. The data review tunnel module may be configured to analyze and review the data stream in conjunction with the data collector module, the interpreter module, and the data review decision rules module.

In certain embodiments, the data review tunnel may validate data in the data stream preferably only if the data review tunnel module receives a validation of the data in the data stream from the data collector module, the interpreter module, and the data review decision rules module.

In some embodiments, the data collector module may be configured to coordinate transportation of data from ingestion at data receipt, and throughout the rest of the multi-spoke data inspection tunnel architecture. The data review tunnel module may be configured to instruct the data reporter module to publish a data report based on the analysis and review of the data stream.

In certain embodiments, the interpreter module may be configured to review data received by the data review tunnel module and to establish a type of data for reference by the data review tunnel module.

The data review decision rules module may be configured to store rules for reviewing and analyzing the data. Such rules may also govern the alteration, correction or other adjustment of reviewed data in the system.

The data reporter module may be configured to prepare a report based on the analysis and review conducted by the data review tunnel module in conjunction with the data review decision rules module, the data interpreter module and the data collector module.

In some embodiments, the data reporter module may only be configured to prepare a report in response to the validation of the data stream, or some part of the data stream, by the data review tunnel module.

A multi-level data channel and inspection architecture is disclosed. The multi-level data pipeline may receive a data stream at an upstream portion of the tunnel and output inspected data at a downstream portion of the pipeline.

The pipeline may include a plurality of pipes. The plurality of pipes may include one or more complementary pairs of pipes. Each pipe within a complementary pair of pipes may be encrypted using a different security key from the security key used to encrypt a second pipe of the same complementary pair of pipes. Encryption of the data stream as it passes through the two pipes in each of the complementary pair of pipes may preferably form a two-key encryption scheme.

The pipeline may also include a data manager configured to coordinate passage of the data into and out of the pipeline. Each of the complementary pairs of pipes is configured to inspect the data on a different level of data channel inspection than any of the other of the complementary pair of pipes, each level of data channel inspection having individual data attribute and/or metadata extracting capabilities.

Each of the complementary pairs of pipes may preferably be coupled in parallel to one another within the multi-level data pipeline. As such, the inputs of each of the complementary pairs may preferably receive, in parallel, some or all of the data from an upstream data stream—inspect the data—and then output the data as inspected data.

In certain embodiments, each complementary pair of pipes may be configured to review and analyze a flow of data through the complementary pair of pipes. The review and analysis of the flow may be directed to, and/or based on, flow characteristics of the data stream.

As described above, each pipe (or both pipes taken together) of the complementary pair of pipes may be configured to carry, and analyze, a partial amount (or even all of) the data stream.

Each complementary pair of pipes is in electronic communication with a second complementary pair of data pipes, the second complementary pair of data pipes operable to review and analyze data at a different security level from the first complementary pair of data pipes. In some embodiments, the first complementary pair of pipes may be in parallel electronic communication with the second complementary pair of pipes. In other embodiments, the first complementary pair of pipes may be in serial electronic communication with the second complementary pair of pipes.

In some embodiments, a first of the plurality of pipes may be configured to transfer only data packets having a first data packet size. The first data packet size may be a size that is equal to or greater than a first threshold size. In such embodiments, a second of the plurality of pipes may be configured to transfer only data packets that have less than the first data packet size. In certain embodiments, the second data pipe may be configured to transfer data packets that have greater than or equal to a second threshold size.

Some embodiments may include a plurality of pipes which may be configured to transfer data packets at greater than or equal to a threshold data transfer rate.

Each of the plurality of pipes may be configured to transfer data packets at less than or equal to a threshold data transfer rate. It should be noted that in such an embodiment, the data packets may have been diverted from a main data stream. The data packets may have been diverted from the main data stream at least because the data packets have been selected for inspection and analysis. The transfer rate of the diverted data packets may need to be slowed for inspection and analysis. Accordingly, the data packets, when travelling in the main data stream, may be flowing at a first data transfer rate. The same data packets, when travelling in the diverted data stream, may be slowed to no greater than a second data transfer rate—where the second data transfer rate is slower than the first data transfer rate.

In certain embodiments, each of the plurality of pipes may be configured to transfer data packets at a data transfer rate that is different from the data transfer rate of the remainder of the plurality of pipes. In some embodiments, each of the plurality of pipes may be configured to transfer data packets at a data transfer rate that is different from the data transfer rate of some of the remainder of the plurality of pipes but the same as, or similar to, the data transfer rate of another portion of the remainder of the plurality of pipes.

In certain embodiments, the plurality of pipes may be configured to transfer data packets a level of data security that is different from the level of data security of the remainder of the plurality of pipes.

A deep packet inspection architecture is provided. The deep packet inspection architecture preferably provides data diversion paths for limiting bandwidth consumption by the deep packet inspection architecture. Bandwidth consumption is limited at least because packets are removed from blocking the higher transfer rate of the main data stream during review and inspection. Instead, data packets are diverted to the lower transfer rate data conduits for review and inspection. It should be noted that, in some embodiments, only a portion of the data packets in the data stream may be diverted for review and inspection.

The diversion paths are preferably formed from a plurality of data conduits. The plurality of conduits preferably include a first data packet inspection conduit and a second data packet inspection conduit. The deep packet inspection architecture preferably diverts data packets selected from a data stream into one of a plurality of data conduits.

The deep packet inspection architecture may preferably include a data packet size determination module. The data packet size determination module may preferably determine a data packet size of a data packet in a data stream.

The deep packet inspection architecture may preferably also include a data packet conduit selection module. The data packet conduit selection module may select, for data packet inspection, a conduit from among the plurality of conduits. The selecting the conduit may depend on a data packet size of the data packet.

In some embodiments, the first data conduit may be configured to receive and inspect data packets that include a data packet size that is greater than a predetermined data packet size. The first data conduit may be further configured to receive, inspect and output data packets at less than or equal to a first transfer rate per unit time. The first transfer rate per unit time includes a magnitude.

The second data conduit may be configured to receive and inspect data packets that include a data packet size that is less than or equal to the predetermined data packet size. The second data conduit may be further configured to receive, inspect and output data packets at a second transfer rate per unit time. The second transfer rate per unit time may include a magnitude that is greater than the magnitude of the first transfer rate per unit time.

In certain embodiments, each of the first data conduit and the second data conduit may each include a complementary pair of data conduits. Each of the complementary pair of data conduits may be operable to review and analyze data packets. In some embodiments, the review and analysis of the data packets may be based on flow characteristics of the data packets in a data stream.

In some embodiments, each of the complementary pair of data conduits is operable to review and analyze the data at a different security level from the other data conduit of the complementary pair of data conduits.

In certain embodiments, each of the complementary pairs of data conduits is coupled in parallel to the other of the complementary pairs of data conduits within the deep packet inspection architecture.

It should be noted that the diverting data packets into plurality of data conduits may be implemented by diverting packets using port mirroring. In other embodiments, the diverting packets may implementing using an optical splitter.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

Conventional data inspections are “vertical” in nature—i.e., data is reviewed and analyzed in such inspections, but no mechanism for intercepting and hiding/altering the data is provided. The following embodiments provide modules and mechanisms for intercepting data and providing necessary review mechanisms for data removal, adjustment and alteration.

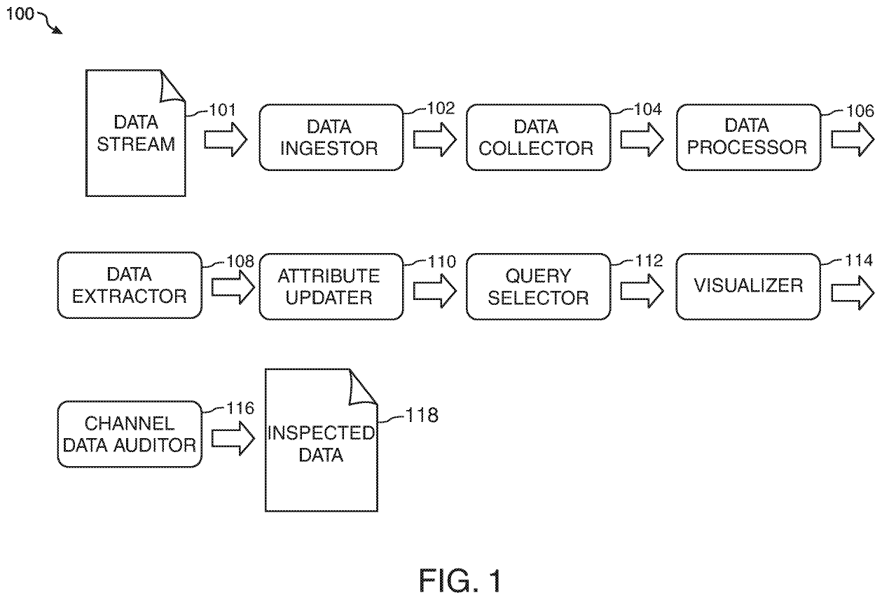

FIG. 1 shows a group of possible audit mechanisms for use along a data pipe 100. Data pipe 100, also referred to herein as one type of a data tunnel review architecture. This group of possible audit mechanism may include data ingestor 102, data collector 104, etc. Each of these mechanisms may be used alone or in some combination with one another. It should be noted that the channel data manager (not shown in FIG. 1) may coordinate passage of the data into, between and out of one or more of the mechanisms.

Data ingestor 102 may serve to bring the data stream 101 into the pipeline. As such, data ingestor 102 preferably is on the externally-facing input side of the data pipeline. It should be noted that each individual pipe in which some or all of mechanisms 101-118 are arranged preferably have different set of requirements regarding data integrity and verity that can be implemented as part of an initial application. These sets of requirements may also support real-time adjustment of data based on real/perceived threats and/or errors in the data.

It should be noted that each of multiple pipes may be arranged with various audit levels. The data manager may force or bypass one or more of input 101, output 118 and mechanisms 102-116, or certain levels within mechanisms 102-116, based on initial and/or subsequent reviews. Such forcing or bypassing may be dependent, in certain embodiments, upon the data attributes/metadata-extracting capability of the individual pipes.

Data collector 104 may preferably coordinates transportation of data from ingestion layer to, and, at times, throughout, the rest of data pipeline.

Data processor 106 preferably processes the collected data from the previous layer. Data processor 106 may serve to route the data to a different destination—the different destination being one that is either in or out of the pipe—and/or classify the data flow. It should be noted that architectures, according to the embodiments, can preferably identify packet flows, rather than conducting a packet-by-packet analysis. This enables institution of control actions based on accumulated flow information. More specifically, many devices can identify packet flows thereby allowing control actions based on accumulated flow information. Such packet flow analysis may include identifying various aspects of the flows and likelihood of whether the packet flows indicate a likelihood of intrusion detection and/or lack thereof—such detection which can lead to classification of the flow as suspect or not suspect.

Data extractor 108 may extract based on data patterns. These patterns enable extractor 108 to mine arbitrary information and extract certain, selected information, from the data which is received and reviewed.

Data attribute updater 110 preferably is configured to add custom properties to data. Such custom properties may include data extracted from primary and secondary data sources to add/remove/edit clarity, value, security or other data attributes. Another example could include adding data markers as each packet, or other segment, of data is inspected. Another example may include adding one or additional layers of tokenization. The additional layers of tokenization may depend on the sensitivity of the data passing through the architecture as well as the availability of custom fields required for certain documents and/or certain classes of documents.

Data query selector 112 provides a layer wherein strong inspection and review processing takes place. Such inspection and review processing may include, for example, validating data extracted via extractor 108 and validating such data against certain policies to meet regulatory, or other relevant, needs.

Data visualizer 114 may be a layer that provides full business infographics, as necessary, to express the static and dynamic results obtained from the ongoing analysis and review (“A & R”).

Data auditor 116 may preferably audit data. In addition, data auditor 116 may provide a supervisory layer for continuously, or periodically, monitoring traced data. Data auditor 116 may preferably output the data as inspected data 118.

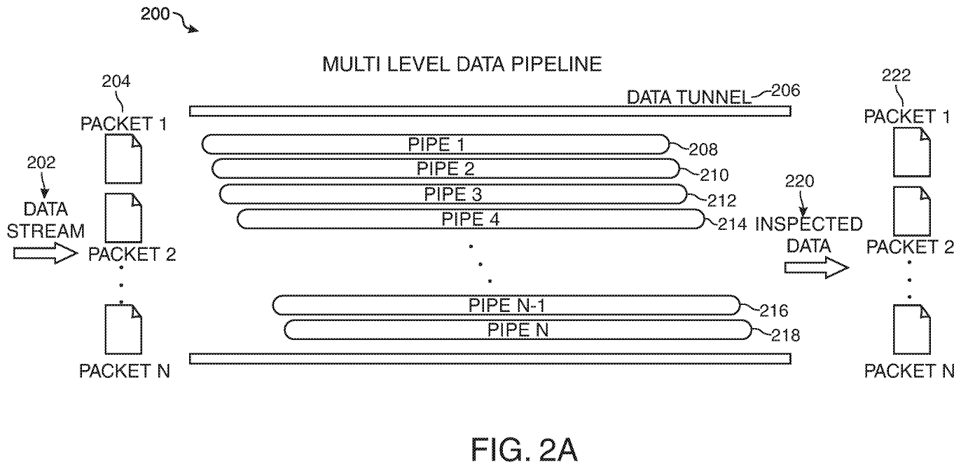

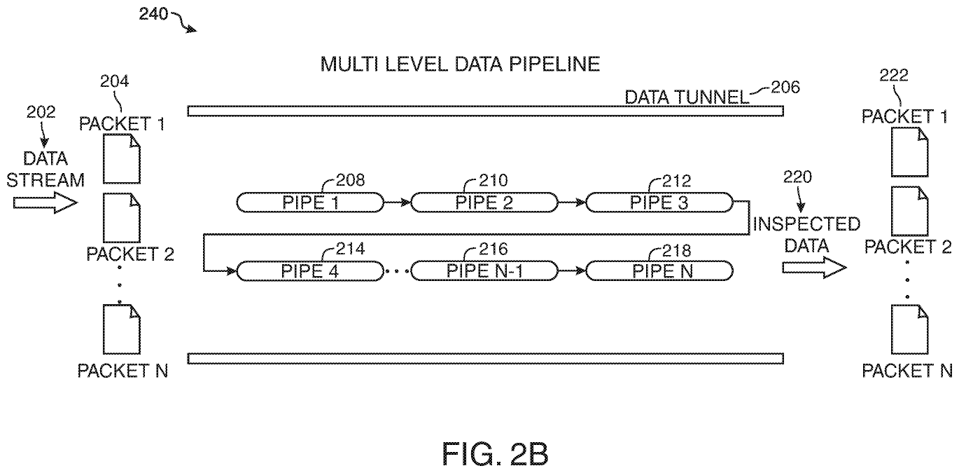

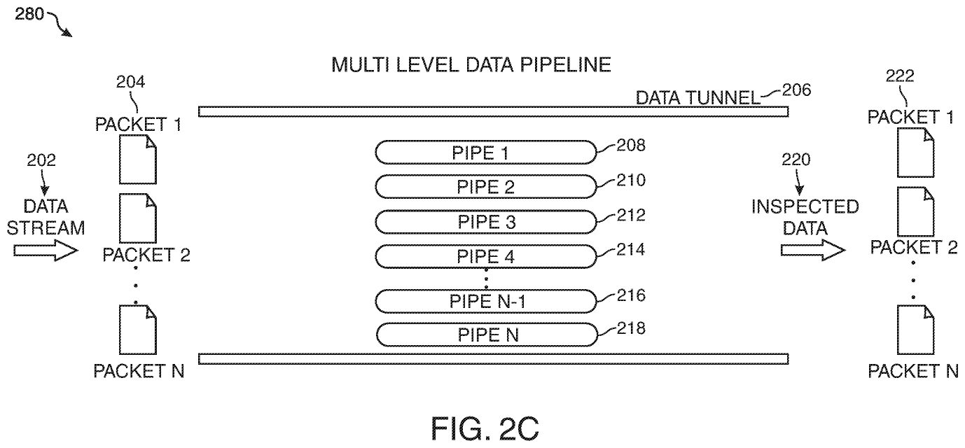

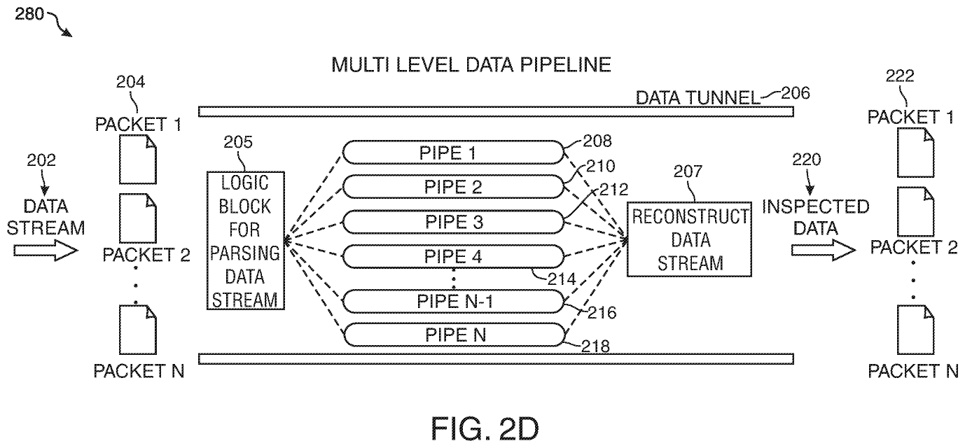

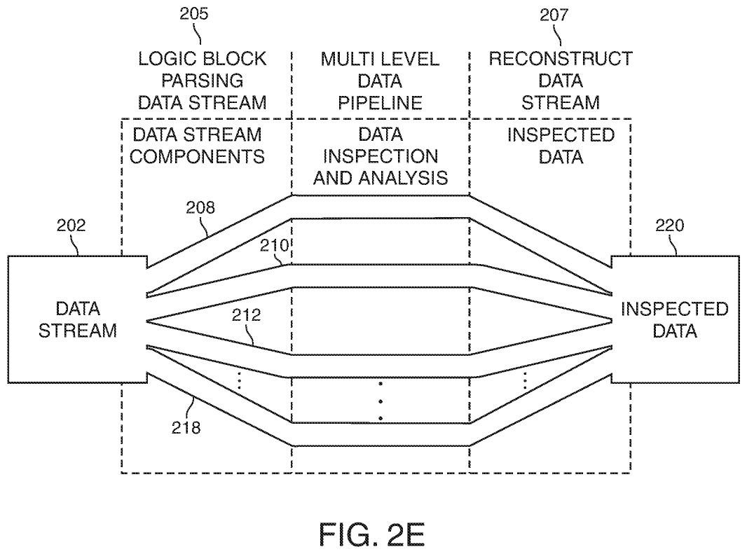

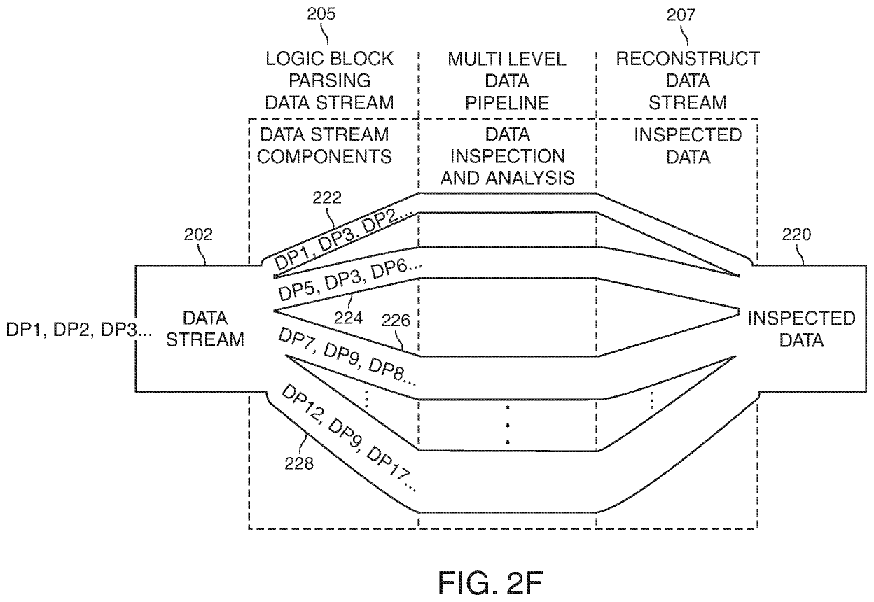

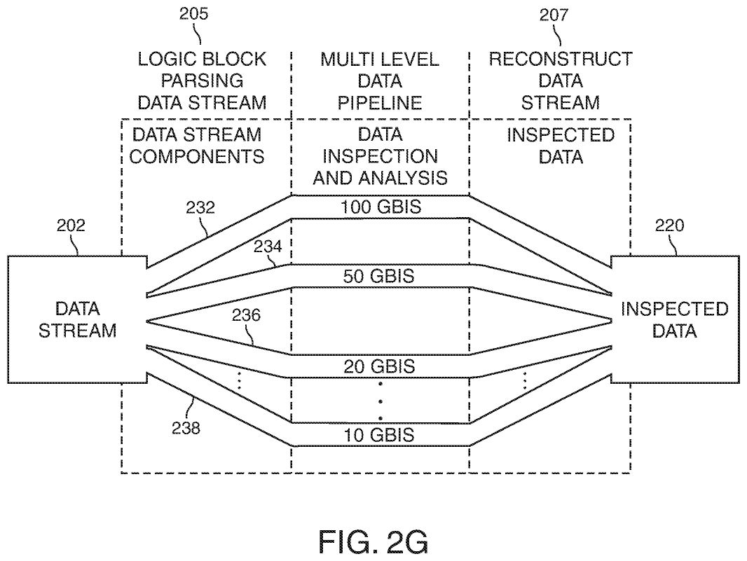

FIG. 2A shows a multi-level data pipeline 200. Multi-level data pipeline 200 preferably includes an incoming data stream 202. Data stream 202 is preferably a candidate for A & R.

Each of pipes 208-218 preferably may include one, some or all of mechanisms 102-114 shown in FIG. 1. In such a pipeline, the coordination of movement of data from one pipe to the next may also require an additional, overseeing data pipeline manager (not shown) that coordinates passage of the data into, between and out of one or more of the pipes 208-218.

It should be noted that the arrangement of pipes 208-218 may be in one of a number of various arrangements. For example, the pipes may be laid out in a serial arrangement—i.e., the output of a first pipe may provide the input for a next pipe and so on. FIG. 2B shows the pipes laid out in serial arrangement 240.

In another arrangement, pipes may be laid out in a parallel arrangement—i.e., all (or some) of the pipes may have inputs that receive different streams and outputs that output different streams. FIG. 2C shows this network architecture. This network architecture, which includes a multi-level data pipeline, shows the various pipes disposed in a parallel fashion 280 in accordance with principles of the disclosure. It should be noted that the decision as to which data goes into which pipe may be handled by, for example, a data pipeline manager (not shown in FIGS. 2A-2C). Such a data pipeline manager may preferably determine based on a suitable algorithm the target address for transmission of the data packets. This target address may depend on, for example, packet size, packet security, and/or any other suitable factor.

In some parallel embodiments, multi-pipe, or multi-tier, data diverters may be implemented. These diverters may serve to reduce bandwidth consumption relating to in-line data review. Each pipe, or tier, may correspond to a security level associated with data packets found in a data stream. For example, a top-level pipe, or tier, may be reserved for reviewing a data stream including data packets that include, or reference, a social security number. A second exemplary pipe or tier may be reserved for reviewing a data stream including data packets that include, or reference, an account number. The security-based arrangement of pipes may also be utilized in accordance with certain embodiments of the serial-based arrangement of the pipes.

In some embodiments, each pipe, or tier, may correspond to a size-dimension associated with data packets found in a data stream. For example, a top-level pipe, or tier, may be reserved for reviewing a data stream including data packets that less than a pre-determined size threshold. In such a pipe or tier, the speed can remain relatively high because the packets are small and can be inspected relatively quickly. A second exemplary pipe or tier may be reserved for reviewing a data stream including data packets that are greater in size than the first threshold but less than a second threshold, etc. The security-based arrangement of pipes may also be utilized in accordance with certain embodiments of the serial-based arrangement of the pipes.

FIG. 2D shows still another illustrative network architecture include a multi-level data pipeline, with various pipes disposed in a parallel fashion, having a front end logic block(s) 205 and/or a back end logic block(s), in accordance with principles of the disclosure.

Logic block 205 preferably serves to parse data stream 202. As described above, logic block may divide data stream into various streams, each including a portion of the data stream 202. Each of such portions may include a portion of the total data stream. It should be understood that, for the purposes of this application, logic block 205 may be used as a deep packet size determination module and/or a deep packet conduit selection module.

FIG. 2E shows, schematically, logic block 205 parsing data stream 202 into pre-determined packets. Each of the packets, depending upon its characterization, may be transferred through one of pipes 208, 210, 212, 214, 216 and 218. Such parsing may include dividing data stream 202 based on the size of packets. As such—all packets having a first packet size, or within a first packet size window, may preferably be transmitted through pipe 208; all packets having a second packet size, or within a second packet size window, may preferably be transmitted through pipe 210, etc.

It should be noted that the relative speed of transmission of each of the pipes should preferably depend, to some extent if not completely, on the size of the packets.

In other embodiments, such parsing may include dividing data stream 202 based on the contents of packets. For example—all packets having a high-security payload, such as a social security number, may preferably be transmitted through pipe 208; all packets having a second security level payload, such as an account number, may preferably be transmitted through pipe 210.

In some embodiments, there may be multiple data pipeline managers that are disposed throughout various pipes 208-218. For example, one data pipeline manager may be assigned to coordinate the movement between pipes 208-212 while another may be assigned to coordinate the movement between pipes 214-218. Alternatively, there may be more data pipeline managers, as needed for the system.

The data stream 202, formed from packets 1 to N at 204, preferably exits as inspected data 220, formed from inspected packets 1 to N at 222.

As described above, data packets (DP1, DP2, DPn) may form a data stream 202. Data stream 202—may be parsed into components. The parsing may break down each data stream 202 into component streams of different packet size.

For example a data stream: DS may be broken down into component data streams DS₁, DS₂, DS₃ . . . DSₙ. The data streams DS₁, DS₂, DS₃ . . . DSₙ may each correspond to a different packet size. DS₁, DS₂, DS₃ . . . DSₙ may correspond to packet size (“PS”) PS₁, PS₂, PS₃ . . . PSₙ.

Further, each PS may preferably be routed to a unique data pipe. As described above, data pipes (L₁, L₂, L₃ . . . Lₙ) may each correspond to a specific packet size one of PS₁, PS₂, PS₃ . . . PSₙ. As such, the size and characteristics each of the data pipe may be customized. The data pipe may be customized based on the type of data packet, and, consequently, the characterization of the partial data stream, that it carries.

As shown in FIG. 2F, each of data pipes 221, 224, 226 and 228 may preferably be configured to carry different packet sizes. Moreover, each of data pipes 221-228 may be configured to have different processing capacities, as signified by the different relative sizes of data pipes 221, 224, 226 and 228 shown in FIG. 2F. Accordingly, each of data pipes 221-228 may be of different actual sizes.

In addition, the speed of processing of each of the data pipes may be different. As shown in FIG. 2G, each of data pipes 232, 234, 236 and 238 may preferably transfer information at different transmission speeds. In some embodiments, the smaller packets may be identified by logic block 205, analyzed and reviewed, and then transmitted at a faster rate, while larger packets may be identified, analyzed and reviewed, and then transmitted at a slower rate. Exemplary rates of 100 gigabytes (“GB”)/second, 50 GB/second etc. are shown in FIG. 2G but any suitable rates may be used in the embodiments. It should be noted that in certain embodiments, all of the pipes may preferably transmit information at a similar rate.

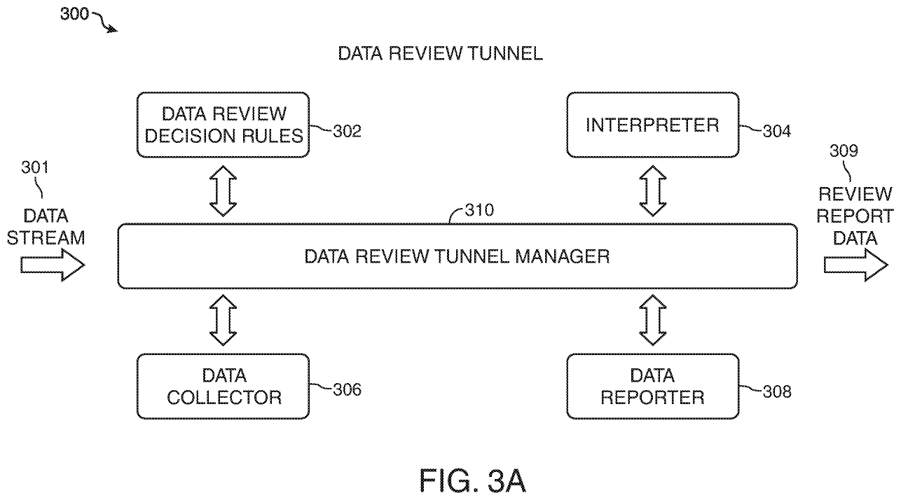

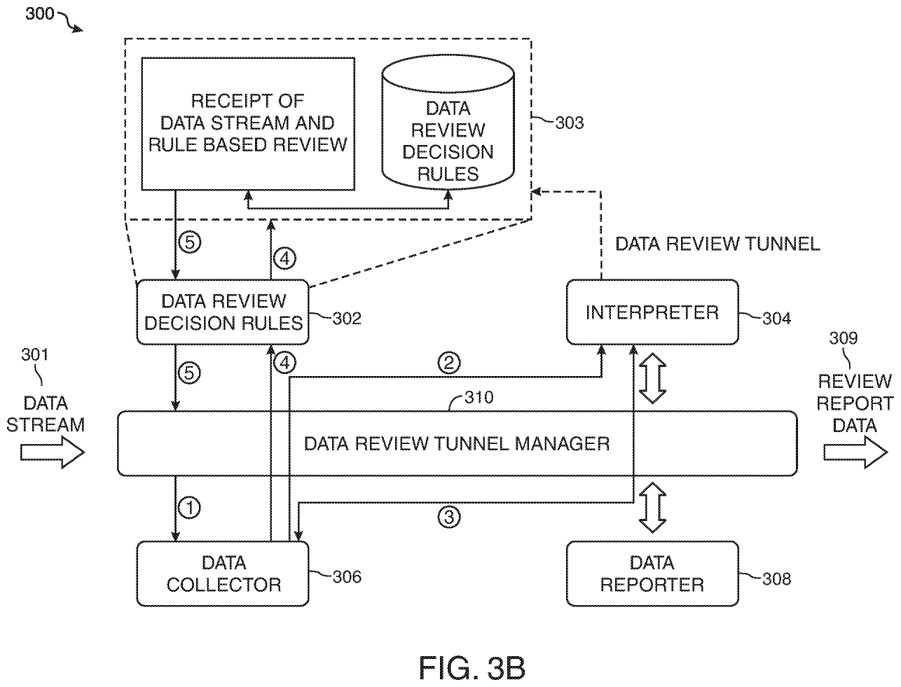

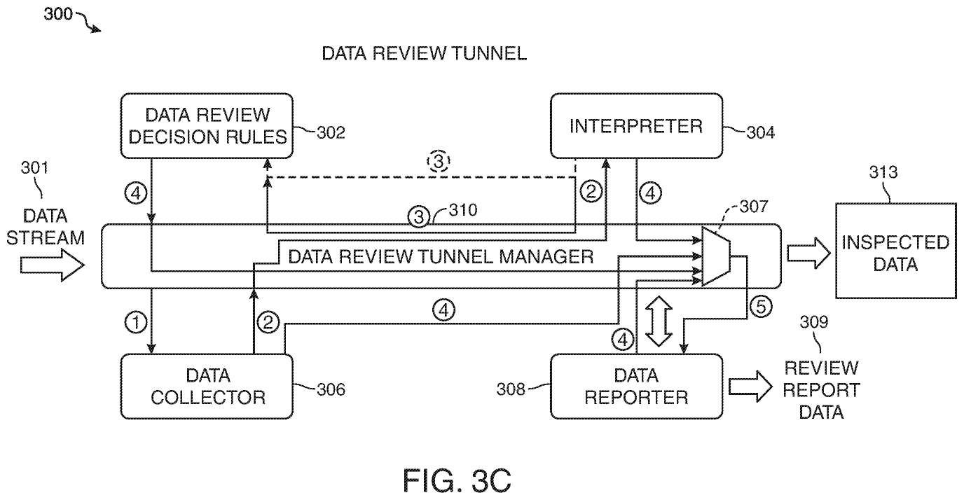

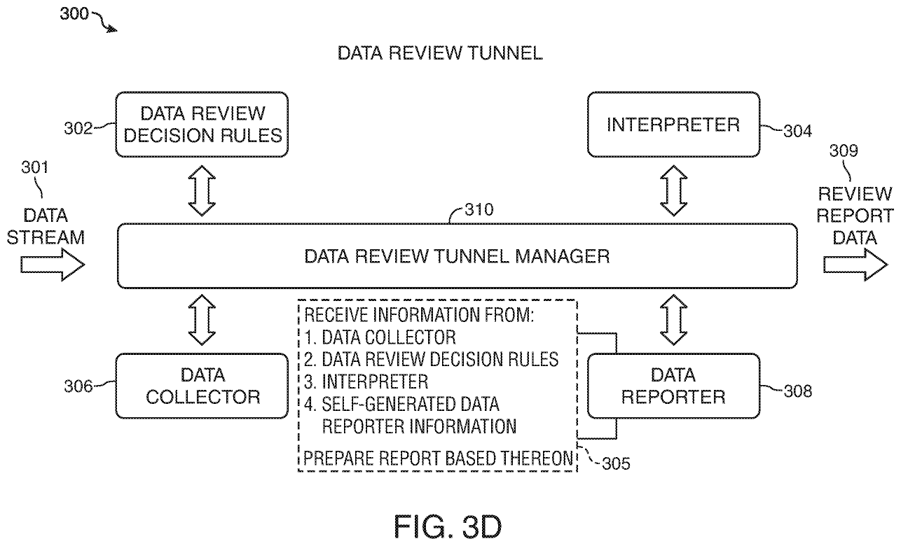

FIG. 3A shows a schematic diagram of an exemplary data review tunnel 300 according to certain embodiments. Data review tunnel 300 preferably includes, and communicates with, data review decision rules module 302, data interpreter module 304, data collector module 306 and/or data reporter module 308. The entirety of the data review, and data movement, and records movement, attendant thereto, is preferably coordinated by data review tunnel manager 310.

The data review decision rules module 302 preferably includes rules for reviewing and analyzing the data. Data review tunnel manager 310 preferably communicates with data review decision rules module 302 to determine the meets and bounds of the analysis and review of data that will take place.

Data collector module 306 preferably is configured to receive, review and analyze data received by data review tunnel manager 310.

Data interpreter module 304 is preferably configured to review data received by data review tunnel manager 310 and to establish the type of data for reference by data review tunnel manager 310. Data reporter module 308 may be configured to prepare a report based on the analysis and review conducted by data review tunnel manager 310 in conjunction with data review decision rules module 302, data interpreter module 304 and data collector module 306.

In certain embodiments, it should be noted that the four “spokes” 302-308 that extend from data review tunnel manager 310, together with data review tunnel manager 310, may form a multiplexer such that any packets that enter spokes 302-308 may require an acceptance by all of spokes 302-308 prior to exiting data review tunnel manager 310. As such, tunnel 300 preferably acts as an AND logic gate which validates, and allows to pass, data packets only after full review and validation at the four different spokes 302-308.

FIG. 3B shows another aspect of the data review tunnel from FIG. 3A in accordance with principles of the disclosure. FIG. 3B illustrates initial steps of a method according to certain embodiments. At (1), data review tunnel manager 310 may deflect—i.e., push—data stream 301 to data collector 306 (or, alternatively, data collector 306 may pull incoming data from data review tunnel manager 310).

In order to appropriately parse the incoming data, data collector 306 may transfer data to interpreter 304, as shown at (2). Following interpretation at interpreter 304, interpreted data may be returned to data collector at (3). Thereafter, at (4), the interpreted data may be transferred for review with respect to the data review decision rules, at 303. In other embodiments, it is foreseen (shown in solid line and, in the alternative, in hashed line in FIG. 3C) that interpreter 304 may transfer the interpreted data directly to data review decision rules 302 for review in view of data review decision rules 302/303.

In either case, data review decision rules 302, at (5), may transfer interpreted data back to data review tunnel manager 310.

FIG. 3C shows yet another aspect of the data review tunnel from FIG. 3A in accordance with principles of the disclosure. In FIG. 3C, data review tunnel manager 310 is shown as multiplexing, at (4), data-based responses from interpreter 304, data review decision rules 302, data collector 306 and data reporter 308 to formulate a unified output. The unified output may output a data validation signal (or an invalid data signal) (not shown), inspected data 313 and/or a data report 309. Data reporter 308 may actually be the module that generates the report, but the report only gets transmitted via data review tunnel manager 310. In such an architecture, data review tunnel manager 310 may perform as a hub for the various spokes that project therefrom. In certain embodiments, the data may be validated, and/or a data report may be produced by data review tunnel manager 310 only if all of the components—i.e., data collector 306, data review decision rules 302, interpreter 304 and data reporter information 305—signal data review tunnel manager 310 to validate the data and/or produce the report.

FIG. 3D shows still another aspect of the data review tunnel from FIG. 3A in accordance with principles of the disclosure. Specifically FIG. 3D illustrates information 305 regarding operation of data reporter 308. In some embodiments, data reporter 308 may operate as follows. It may receive, via data review tunnel manager 310, information from data collector 306, data review decision rules 302, interpreter 304 and may even produce some of its own self-generated data reporter information, as shown in 305.

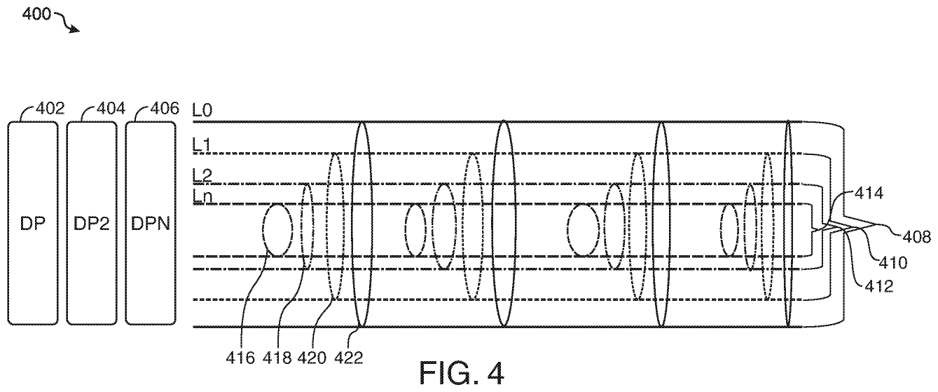

FIG. 4 shows a schematic diagram of an exemplary arrangement 400 of data review tunnels 416-422 as they intersect with a plurality of complementary pipe (or alternatively, “data conduits”) pairs 408-412. Data packets 402-406 are shown to the left as entering and traveling through pipe pairs 408-412.

Pipe pairs 408-412 are shown as complementary pairs as opposed to single data pipes. The complementary pairs enable the arrangement 400 to process large amounts of real-time or streaming data.

In certain embodiments, the complementary pairs of pipes 408-412 may illustrate schematic descriptions of double-key systems. For example, when a first entity wants to contact a second entity using electronic communication, the first entity may encrypt the transmission using a first encryption key. On the receiving end, the second entity, may decode the transmission using the key with which the first entity encoded the information. However, if a malicious actor breaks the encryption key, then the communication is in danger of a security breach.

In order to increase security, the transmitter of information may transmit information over two pipes instead of one. In order to hack such a transmission, a malicious actor will be required to hack both information pipes in order to reconstruct the transmission. If an even greater level of security is desired, then the two-pipe solution can implement two security keys. For example, if the transmitter uses a public key provided by the recipient to encrypt the transmission and then further encrypts the transmission using a the transmitter's own private key, then the recipient will be required to decode the transmission using both the public key and the private key. The security of the transmission will be further heightened by using dual (or more) transmission pipes to transmit the transmission.

Tunnels 416-422 may be configured as data review tunnels 300 set forth in FIG. 3. Tunnels 416-422 are shown as intersecting both complementary pipes of each of pairs 408-412. In such an architecture, tunnels 416-422 can provide the data channeling sufficient for implementing the processing, et al., shown in FIG. 3. Tunnels 416-422 preferably stretch across both pipes because the information in both pipes is preferably critical to performing analysis and review of the information in both pipes.

The data channeling described herein in the portion of the specification corresponding to FIGS. 1-4 may support real-time or near real-time data inspection and review. Furthermore, the data channeling may enable efficient control and data attribute/metadata extraction to compare against data records stored in a System of Record/Registration (“SOR”) and/or Authorized Data Source (“ADS”).

Preferably all of the embodiments shown herein allow for certain data stripping capabilities based on SOR and/or ADS including the ability to compare and/or correct inconsistent data—i.e., data that does not conform to the SOR and/or the ADS.

Moreover, the systems and architectures described herein preferably provide the ability to dynamically freeze one or more data channels with respect to one or more data packets/streams. Freezing a data channel may be required in a data breach situation or other emergency situation. In addition, the systems and architectures described herein preferably allow certain data to pass based on a pending registration/attribute review, or put in a holding pattern and/or holding zone pending the exit of frozen data currently stuck in the channel.

In certain embodiments of the architectures shown in FIG. 1-4, the pipes could have different set of requirements that can be implemented as part of an initial application but also support real-time adjustment based on real/perceived threats or any other selected stimuli.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for multi-spoke data tunnel inspection architectures are provided. Persons skilled in the art will appreciate that the present invention can be practiced by other than the described embodiments, which are presented for purposes of illustration rather than of limitation, and that the present invention is limited only by the claims that follow.

1. A deep packet inspection architecture, said deep packet inspection architecture for providing data diversion paths for limiting bandwidth consumption by the deep packet inspection architecture, said diversion paths formed from a plurality of data conduits, said plurality of conduits comprising a first data packet inspection conduit and a second data packet inspection conduit, said deep packet inspection architecture for diverting data packets selected from a data stream into one of a plurality of data conduits, the deep packet inspection architecture comprising:
a data packet size determination module, said data packet size determination module for determining a data packet size of a data packet in a data stream;
a data packet conduit selection module, the data packet conduit selection module for selecting, for data packet inspection, a conduit from among the plurality of conduits, said selecting the conduit that depends on a data packet size of the data packet; and
wherein the first data conduit is configured to receive and inspect data packets that include a data packet size that is greater than a predetermined data packet size, said first data conduit that is further configured to receive, inspect and output data packets at less than or equal to a first transfer rate per unit time, said first transfer rate per unit time that comprises a magnitude;
the second data conduit is configured to receive and inspect data packets that include a data packet size that is less than or equal to the predetermined data packet size, said second data conduit that is further configured to receive, inspect and output data packets at a second transfer rate per unit time, said second transfer rate per unit time that comprises a magnitude that is greater than the magnitude of the first transfer rate per unit time;
wherein the selected data packets are compared against data records stored in an Authorized Data Source to validate the data; and
wherein the selected data that does not conform to the ADS is stripped or corrected.

2. The architecture of claim 1, wherein each of the first data conduit and the second data conduit comprises a complementary pair of data conduits.

3. The architecture of claim 2, wherein each of the first and second data conduits is operable to review and analyze data packets.

4. The architecture of claim 3, wherein each of the first and second data conduits is operable to review and analyze the data at a different security level from the other data conduit.

5. The architecture of claim 2, wherein each of the complementary pairs of data conduits is coupled in parallel to the other of the complementary pairs of data conduits within the deep packet inspection architecture.

6. The architecture of claim 3, wherein said review and analysis of the data packets is based on flow characteristics of the data packets in a data stream.

7. The architecture of claim 1, wherein said diverting data packets into plurality of data conduits comprises diverting packets using port mirroring or using an optical splitter.

8. A deep packet inspection architecture, said deep packet inspection architecture for providing data diversion path for limiting bandwidth consumption by the deep packet inspection architecture, said diversion paths formed from a plurality of data conduits, said plurality of conduits comprising a first data packet inspection conduit and a second data packet inspection conduit, said deep packet inspection architecture for diverting data packets in a data stream into one of the plurality of data conduits, said data stream that transfers data packets at a first transfer rate per unit time, the deep packet inspection architecture comprising:
a data packet size determination module, said data packet size determination module for determining a data packet size of a data packet in the data stream;
a data packet conduit selection module, the data packet conduit selection module for selecting, for data packet inspection, a conduit from among the plurality of conduits, said selecting the conduit that depends on a data packet size of the data packet;
wherein the first data conduit is configured to receive and inspect data packets that include a data packet size that is greater than a predetermined data packet size, said first data conduit that is further configured to receive, inspect and output data packets at a second transfer rate per unit time, said second transfer rate per unit time that is less than said first transfer rate per unit time;
the second data conduit is configured to receive and inspect data packets that include a data packet size that is less than or equal to the predetermined data packet size, said second data conduit that is further configured to receive, inspect and output data packets at a third transfer rate per unit time, said third transfer rate per unit time that is less than the first transfer rate per unit time and greater than the second transfer rate per unit time;
wherein the selected data packets are compared against data records stored in an Authorized Data Source to validate the data;
wherein the selected data that does not conform to the ADS is stripped or corrected.

9. The architecture of claim 8, wherein each of the first data conduit and the second data conduit comprises a complementary pair of data conduits.

10. The architecture of claim 9, wherein each of the data conduits is operable to review and analyze data packets.

11. The architecture of claim 10, wherein each of the data conduits is operable to review and analyze the data at a different security level from the other data conduit.

12. The architecture of claim 9, wherein each complementary pair of data conduits is coupled in parallel to the other of the complementary pair of data conduits within the deep packet inspection architecture.

13. The architecture of claim 10, wherein said review and analysis of the data packets is based on flow characteristics of the data packets in a data stream.

14. The architecture of claim 8, wherein said diverting data packets into plurality of data conduits comprises diverting packets using port mirroring or using an optical splitter.

15. A method for providing deep packet inspection the method comprising:
providing data diversion paths, said diversion paths formed from a plurality of data conduits, for limiting bandwidth consumption by the deep packet inspection architecture;
diverting data packets in a data stream into a selected one of the plurality of data conduits, said data stream that transfers data packets at a first transfer rate per unit time
determining a data packet size of a data packet in the data stream;
selecting, for data packet inspection, a conduit from among the conduits, said selecting the conduit that depends on a data packet size of the data packet;
wherein the first data conduit is configured to receive and inspect data packets that include a data packet size that is greater than a predetermined data packet size, said first data conduit that is further configured to receive, inspect and output data packets at a second transfer rate per unit time, said second transfer rate per unit time that is less than said first transfer rate per unit time;
the second data conduit is configured to receive and inspect data packets that include a data packet size that is less than or equal to the predetermined data packet size, said second data conduit that is further configured to receive, inspect and output data packets at a third transfer rate per unit time, said third transfer rate per unit time that is less than the first transfer rate per unit time and greater than the second transfer rate per unit time; and
wherein the diverted data packets are compared against data records stored in an Authorized Data Source to validate the data;
stripping or corrected the diverted data packets that do not match the data records stored in the Authorized Data Source.

16. The method of claim 15, wherein each of the first data conduit and the second data conduit comprises a complementary pair of data conduits.

17. The method of claim 16, wherein each of the complementary pair of data conduits is operable to review and analyze data packets.

18. The method of claim 17, wherein complementary pair of data conduits is operable to review and analyze the data at a different security level from the other data conduit of the complementary pair of data conduits.

19. The method of claim 16, wherein each of the complementary pairs of data conduits is coupled in parallel to the other of the complementary pairs of data conduits within the deep packet inspection architecture.

20. The method of claim 17, wherein said review and analysis of the data packets is based on flow characteristics of the data packets in a data stream.

21. The method of claim 15, wherein said diverting data packets into plurality of data conduits further comprises diverting packets using port mirroring or using an optical splitter.
